(19) United States
(12) Patent Application Publication
(10) Pub. No.: US 2008/0142555 A1
(43) Pub. Date: Jun. 19, 2008

(54) Device for Applying a Fluid to an Area to be Treated, Comprising a Timing System

(75) Inventors: Denis Marin, Bailly (FR); Serge Sonie, La Riviere Saint-Sauveur (FR)

Correspondence Address: IP GROUP OF DLA PIPER US LLP, ONE LIBERTY PLACE, 1650 MARKET ST, SUITE 4900, PHILADELPHIA, PA, 19103, US

(73) Assignee: Persee Medica

(21) Appl. No.: 11/919,149

(22) PCT Filed: Apr. 28, 2006
(86) PCT No.: PCT/FR2006/000968

§ 371 Date: Jan. 22, 2008

(30) Foreign Application Priority Data
Apr. 28, 2005 (FR) 05/04319
Mar. 31, 2006 (FR) 06/02833

(51) Int. Cl. G04C 23/00

(52) U.S. Cl. 222/645; 222/504

(57) ABSTRACT

A device for application of a fluid to an area to be treated including a reservoir of fluid contained in an aerosol and maintained in a device in the form of a casing, and means for triggering release of the fluid from the reservoir via an ejection nozzle, wherein means of triggering release of the fluid are coupled with a time system controlling duration of release of the fluid.

### RELATED APPLICATION

This is a §371 of International Application No. PCT/FR2006/000968, with an international filing date of Apr. 28, 2006 (WO 2006/114533 A1, published Nov. 2, 2006), which is based on French Patent Application Nos. 05/04319, filed Apr. 28, 2005, and 06/02833, filed Mar. 31, 2006.

### TECHNICAL FIELD

This disclosure concerns the area of dispensing a fluid contained in an aerosol and maintained in a device in the form of a casing. The disclosure more particularly relates to a device allowing control of ejection of the fluid at the outlet of the device and restriction of its application to the area to be treated alone, and modulation of its mode of action and the time in a pre-established manner depending on the type of application to be treated.

### BACKGROUND

U.S. Pat. No. 5,098,428 discloses a cryosurgical instrument in contact with a liquefied cooling gas contained in a thermally insulated container. When the normal discharge to atmospheric pressure of the container is interrupted, the pressure of the liquefied cooling gas in the container can be increased by a small balloon. This pressure causes the liquefied cooling gas to be sprayed through the nozzle until normal discharge to atmospheric pressure is restored. That instrument is highly sensitive to the conditions of use (atmospheric pressure, temperature) and to the residual quantity of liquefied gas which varies during successive uses. Consequently, the characteristics of the sprayed gas vary from one use to another in terms of pressure, temperature and quantity.

U.S. Pat. No. 6,296,410 discloses a device designed to administer a specific quantity of a liquid cooling agent. That device comprises: a container serving to hold the liquid cooling agent; a valve which is normally closed connected to the container; and a means of operation serving to temporarily open the valve, comprising a positioning device serving to position at least a portion of the administration element, so that the cooling agent leaving the valve is able to reach the administration element. According to a first embodiment, the positioning device comprises a chamber which is connected to the valve and into which the cooling agent is introduced during operation of the valve, the chamber being designed to receive at least a portion of the administration element. By its very nature, that type of device does not allow control of the quantity of gas sprayed and the duration of application of the gas, the utilization time being extremely unpredictable and variable from one user to another and also with the same user.

Thus, known dispensing devices typically present several disadvantages in that they do not allow precise control of the quality of fluid and the duration of application to an area to be treated.

It is the case that, when a cold fluid is applied to an area of infected skin for therapeutic or cosmetic purposes, failure to observe the posology required in terms of dosages and application time contributes to rendering action of the fluid ineffective or even to illegitimately aggravating the disorder to be treated. Part of the nature of these applications is to be identically reproducible. This necessarily implies the ability to precisely control the quantity of fluid sprayed and its duration of application to the area to be treated.

### SUMMARY

We provide a device for application of a fluid to an area to be treated including a reservoir of fluid contained in an aerosol and maintained in a device in the form of a casing, and means for triggering release of the fluid from the reservoir via an ejection nozzle, wherein means of triggering release of the fluid are coupled with a timer system controlling duration of release of the fluid.

### BRIEF DESCRIPTION OF THE DRAWINGS

Our devices will be better understood with the aid of the description of a representative example provided below for purely explanatory purposes, with reference to the appended figures:

FIG. 1 illustrates a perspective view of the timer allowing dispensing of the fluid by the dispensing device according to a determined quantity and duration, the timer being stopped;

FIG. 2 illustrates a top view of the timer in FIG. 1, the time being running;

FIG. 3 illustrates a cross-sectional view of the ejection nozzle of the fluid application device;

FIG. 4 illustrates a partial view of the fluid application device in addition to the associated pushbutton;

FIG. 5 illustrates a cutaway view of a lateral side of a fluid application device;

FIGS. 6 and 7 illustrate cutaway views of the other lateral side of the device in FIG. 5; and

FIG. 8 illustrates a detailed view of the timer triggering system.

### DETAILED DESCRIPTION

We provide devices controlling dispensing of a fluid and restriction of its application to a previously determined quantity and duration.

Our devices are designed specifically, but not exclusively, for all treatments of dermal infections such as warts, corns, growths and brown spots or any local application to the skin, the mucosae, the tissues or any other part of the human or animal body, whether on a medical, techical or cosmetic level.

Such devices have the advantage of being capable of completely safe use by a user other than a person from the medical profession, with the user having no direct control over the duration of application and the quantity of fluid to be applied to the aforementioned area to be treated.

To do this, we provide a device for application of a fluid to an area to be treated of the type comprising a reservoir of fluid in the form of an aerosol and means to trigger release of the fluid from the reservoir through an ejection nozzle, wherein the means of triggering release of the fluid are coupled to a timer system controlling the duration of release of the fluid.

The timer system is of a mechanical type comprising a gear system of cogwheels.

The timer system may comprise a cogwheel controlling starting and stopping of the timer, with the movement of the wheel being controlled by a pivoting lever arm interdependent of the means of triggering.

Preferably, the wheel comprises a roughly circular rib, the rib being provided on its outside edge with a tab which halts the movement of the lever arm along the outside edge of the rib.

The wheel may comprise a second rib radially locking the pivoting lever arm, with the first and second ribs being arranged to form a guide rail for the pivoting lever arm.

Furthermore, it may be made for the timer system of the fluid application system requiring prior priming. To this end, the pivoting lever arm will be advantageously moved to an intermediate locking position by means of a rearming lever interdependent of the cam.

For a configuration of this type, it may also be made for the rib having, on its outer edge, a roughly radial extension, the extension allowing the pivoting lever arm to be held in its preliminary locking position.

The timer system may be of a mechanical type comprising a gear system of cogwheels, with the gear system advantageously having at least two wheels: a first wheel controlling starting and stopping of the timer; a second wheel controlling release or discontinuation of release of the fluid from the reservoir to the ejection nozzle.

Advantageously, the first wheel is operated by the means of triggering via an arm forming a lever, the arm forming a lever being articulated to pass from a lowered position on the first wheel to a raised position and vice versa.

Advantageously, the timer system comprises first means of stoppage provided with the arm forming a lever and intended to act on the first gear system. The means of stoppage may consist of a lug arranged on one of the ends of the arm, the lug being configured to rest in a lumen formed in the first wheel when the arm forming a lever is in the lowered position.

Advantageously, the first wheel comprises second means of stoppage provided with the first wheel, the second means of stoppage being intended to assist the first means of stoppage provided with the arm forming a lever. One will subsequently speak of safety stop means. The purpose of these means is to allow operation of the timer to be blocked once the application time of the fluid has elapsed, independently of any action on the device by the user. The timer comprising such safety stop means therefore has the advantage of avoiding any overrun of application of the fluid in case of continued or prolonged activation of the means of release of the fluid manifesting itself in the arm forming a lever being held in the raised position.

The safety stop means may consist of a lug sized to contact the arm forming a lever when the arm forming a lever is in the raised position.

Advantageously, the first wheel is driven by a traction spring surrounding the third wheel, the third wheel being in contact with the second wheel such that, when the arm forming a lever is in the raised position, the first wheel is driven by the traction exerted on the third wheel by the spring.

With regard to the second wheel, the function of the latter is to control release or discontinuation of release of the fluid by means of a release arm. For this purpose, the free end of the arm bears means capable of activating opening or closing of the ejection nozzle.

The following description concerns a device allowing application of a defined quantity of fluid to an area of skin to be treated according to specific duration of application to treat skin infections.

The fluid may have a boiling point less than or equal to −20° C. and a latent vaporization heat less than or equal to 200 kJ/kg. The specific combination of these two characteristics for the fluid makes it possible to achieve optimum efficacy for the cryotreatments or cryoapplications involved. Indeed, the boiling temperature makes it possible to obtain the necessary cold and the relatively limited latent vaporization heat, rapid evaporation which results in good trans-mission of the cold without any risk of the fluid flowing outside the area of application. Consequently, use of the fluid makes it possible to obtain a “dry” and intense cold, while limiting aggressiveness of the treatment at the area of application. In one example, the fluid is a HFC of type 152A, with a boiling temperature of −24° C. and a latent vaporization heat equal to 160 kJ/kg.

The quantity and duration of application of the fluid are defined according to the use for which the device is intended. When wart treatment is involved, since the cold required is intense, the area is localized to 3 to 10 millimeters in diameter and preferably on the order of 6 millimeters and the fluid is to be advantageously sprayed to the area for at least one second. When treatment of brown spots is involved, since the cold required is less intense, the area is localized to 0.5 to 2 centimeters and preferably on the order of 1.5 centimeters and the fluid is to be advantageously sprayed on the area for at least one second.

Our devices allow for prior adjustment of the duration of application according to the desired type of action on the skin and according to the type of problem to be solved. Consequently, since the level of effect required is different according to each problem, prior adjustment offers the user a much greater guarantee and efficacy than individual assessment. Indeed, it is by means of many tests repeated in a large number of clinical cases that these prior adjustments have been tested.

With regard to application of the fluid to the area to be treated alone, this is achieved as a result of the design of the device and more specifically as a result of the shape and configuration of the ejection section (ejection nozzle) of the device.

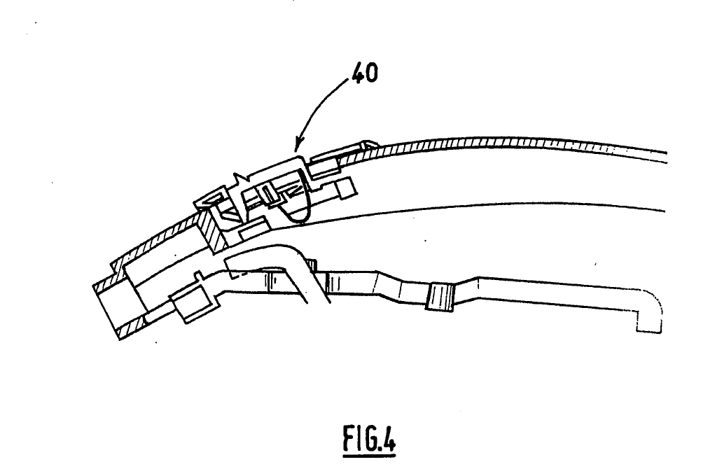

The device (1) for application of the fluid is of a type comprising a reservoir of fluid in the form of an aerosol, the fluid being released through an ejection nozzle by the action of a pushbutton (40) illustrated in FIG. 4. An example of configuration and operation of an ejection nozzle will be described in detail below.

Device (1) is remarkable in that the pushbutton (40) is coupled to a timer allowing control of the duration and release of the fluid and therefore the duration of application of the fluid to the area to be treated.

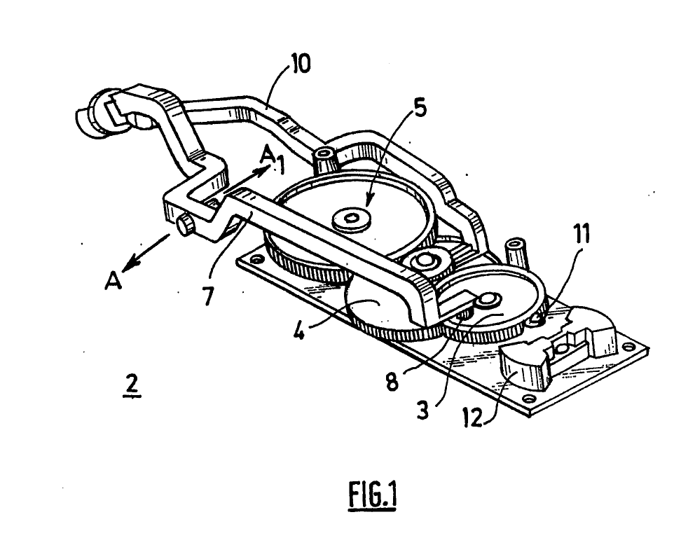

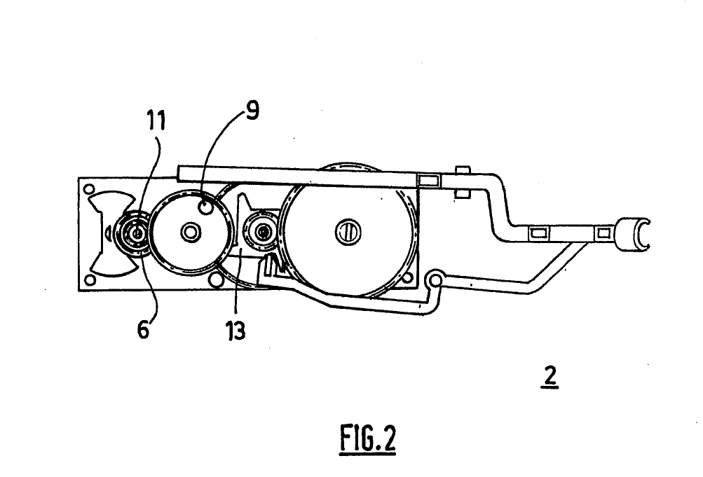

FIGS. 1 and 2 illustrate a perspective view of a first configuration of the timer (2) forming the device (1), the timer (2) being respectively stopped and running.

The term “timer” means a timer system comprising the elements making up the timer itself, in addition to the means used to trigger its operation and/or cause it to stop.

The timer (2), of a mechanical type, comprises a gear system of cogwheels, including:
a first wheel (3) activating starting and stopping of the timer. This wheel will be known hereafter as the “cycle wheel.”
a second wheel (4), known hereafter as the “cam wheel,” controlling release or discontinuation of release of the fluid by the ejection nozzle.

The cycle wheel (3) is connected to the pushbutton (40) via an arm forming a lever pivoting around a pivoting axis AA1 to move from a lowered position on the cycle wheel (3) to a raised position and vice versa.

Advantageously, the arm forming a lever (7) comprises means of stoppage designed to maintain the cycle wheel (3) immobilized. The means of stoppage may comprise a lug arranged at the end of the arm (7), the lug of which (8) is configured to rest in a hole (9) formed in the cycle wheel (3).

Consequently, when the arm forming a lever (7) is in the lowered position and the lug (8) is inserted into the hole (9) of the cycle wheel (3), the cycle wheel (3) is kept immobilized.

As for the cam wheel (4), it controls release or discontinuation of release of the fluid by means of a release arm (10). To do this, the release arm (10) has an end which is interdependent with the cam wheel (4), with the other end being provided with a magnetic field, controlling opening or closing of the ejection nozzle. Control of opening and closing of the nozzle will be described below.

Operation of the timer (2) of the device (1) is as follows.

The arm forming a lever (7), when it is maintained in the lowered position, blocks the cycle wheel (3) by means of the lug (8) of the arm forming a lever (7), the lug resting in the hole (9) of the cycle wheel (3). The timer (2) is in stop status in this case, with all the gears being maintained in a locked position.

Operating the pushbutton (40) triggers pivoting of the arm forming a lever (7), which moves from its lowered position on the cycle wheel (3) to a raised position, such that lug (8) of the arm forming a lever (7) is moved out of the hole (9).

No longer being held back by the arm forming a lever (7), the cycle wheel (3) is subsequently driven by a drive wheel (5) by means of a traction spring (not illustrated). To this end, the spring fixed to the cycle wheel (3) by one of its ends is installed coiled around the drive wheel (5). The spring is advantageously coiled to have energy allowing dispensing of at least ten doses of fluid, i.e., ten treatments, with one complete revolution of the cycle wheel (3) corresponding to dispensing of a dose of fluid.

In the same manner, the drive wheel (5), set in movement by the action of the spring, drives in cascade formation the other wheels forming the timer (2).

Advantageously, the cycle wheel (3) is in contact, by means of an escapement wheel (6) and a pinion (11) mounted on the axis of the escapement wheel (6), with a metallic component (12) capable of oscillating in response to touch by the cycle wheel (3). The oscillation frequency of the metallic component is related to the shape and the mass of the metallic component itself, but also to the shape of the escapement wheel (shape and number of teeth). The purpose of the metallic component (12) is to act on the speed of the timer (2).

In parallel, driven by the drive wheel (5), the cam wheel (4) operates by means of the cam (13) located on the cam wheel (4) the release arm (10) of the fluid to open and subsequently close the ejection nozzle of the device (1).

Running of the timer (2) subsequently ends either by automatic repositioning of the lug (8) of the arm forming a lever (7) in the hole (9) of the cycle wheel (3) (case in which the user has operated and subsequently released the pushbutton before the end of a treatment cycle), or by contact of a lug formed on the wheel against the arm forming a lever (7) (case in which the user continuously operates the pushbutton).

Indeed, supposing that the user continuously operates the pushbutton (40), thereby maintaining the end of the arm forming a lever (7) in the raised position and consequently the timer (2) in a constant state of operation until the pressure on the pushbutton (40) is released, the timer (2) advantageously includes secondary means of safety stoppage (not illustrated). The cycle wheel (3) bears the means of safety stoppage. More specifically, the means of safety stoppage includes a lug formed on the face of the cycle wheel (3) which is intended to come into contact with the arm forming a lever (7) once the cycle wheel has completed a full revolution. The lug is arranged on the cycle wheel (3) and sized such that when the arm forming a lever (7) is maintained in the raised position, the lug rests against the latter.

Consequently, regardless of the use which is made of the device (1), the latter is such that a single dose cannot be applied to the area to be treated from the moment that the pushbutton (40) has initially been pressed once (continuously or not), the dose being applied until the end of dispensing of the predetermined quantity of fluid for the predetermined time.

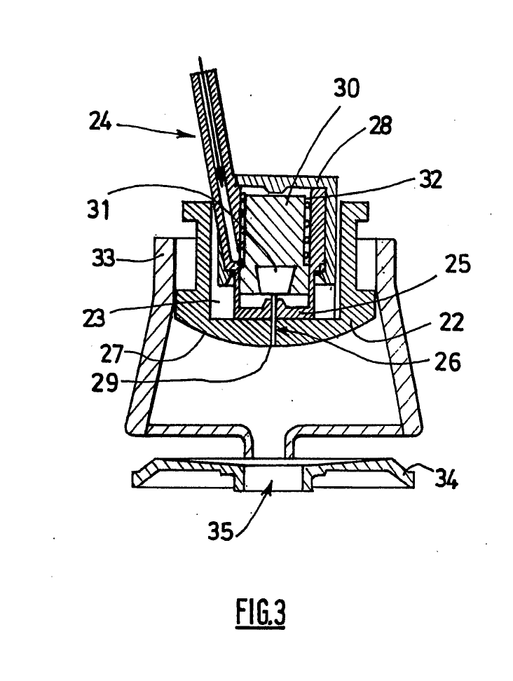

FIG. 3 illustrates a cross-section of the ejection nozzle (22) with which the fluid application device (1) according to the invention is equipped.

The nozzle (22) includes a hollow body in which a casing (23) defining a cavity (25) designed to receive the fluid coming from a reservoir (not illustrated) via a duct (24). Advantageously, the upper part of the casing (23) is formed by a cover (28).

The nozzle (22) comprises a duct (26) passing from one side to the other through the body of the nozzle (22) and the casing (23) housing in the nozzle (22).

Advantageously, the duct (26) is equipped with a tubular ferrule (29), with one of the ends of the ferrule (29) emerging into the cavity (25) by a few millimeters and the other end emerging onto the ejection head (27) of the nozzle (22). The ferrule (29) has an internal diameter of 0.1 millimeters to 0.8 millimeters and preferably on the order of 0.3 millimeters and a length of 3 to 9 millimeters and preferably on the order of 6 millimeters. Owing to its dimensions, the ferrule (29) ensures the flow rate of the jet and contributes, together with the shape of the ejection head (27) of the nozzle (22), to the form of the jet of fluid. Consequently, when the area of the ejection head (27) located around and in the vicinity of the outlet orifice of the ferrule (29) is convex in shape, the jet of fluid is fine and when it is concave in shape, the jet of fluid is wide. It is therefore possible, by playing on the shape of the ejection head (27) of the nozzle (22) and on the internal diameter of the ferrule (29) to adapt the shape of the jet to the infection to be treated. It should be noted that the term “jet” implies a gas/liquid mixture.

A slide valve (30) is installed sliding in the cavity (5) formed by the casing (23). More specifically, the slide valve (30) is configured to slide from a position closing the end of the ferrule (29) (or duct 26) emerging into the cavity (25) (closing position) to a position leaving the end of ferrule (29) open to the fluid and conversely. The ferrule (29) is closed by a plug (31) made of elastomer arranged on the lower side of the slide valve (30) in contact with the ferrule (29) to ensure a seal.

The slide valve (30) slides under the action of a magnetic field controlled by the timer described above, the slide valve (30) being made at least in part of a magnetic material. The slide valve (30) is moved to the closing position by means of a spring (32) partially arranged around the slide valve (30).

Consequently, when the device (1) is in the non-operational state, the plug (31) made of elastomer of the slide valve (30) is forced against the end of the ferrule (29) emerging into the cavity (25) by means of the spring (32). The fluid, originating from the reservoir is maintained in this case in the space formed between the casing (23) and the slide valve (30).

Under the action of the magnetic field arranged above the cover (28), the slide valve (30) is moved from its closing position to its opening position to allow discharge through the ferrule (29) of the fluid entrapped between the casing (23) and the slide valve (30). The movement of the slide valve (30) is stopped by the cover (28).

When the magnet is removed or placed at a sufficient distance from the cover (28), the spring (32) pushes the slide valve (30) back in the direction of the ferrule (29) to the point of blocking again the orifice of the ferrule (29) by the plug (31) made of elastomer of the valve (32).

The device (1) is furthermore equipped with a protection end piece (33).

The purpose of the protection end piece (33) is to create a sufficient distance between the area to be treated (skin) and the outlet of the cold fluid. The purpose of the protection end piece (33) is also to avoid any contact between the ejection head (27) of the nozzle (22) with the infected area to be treated. It is indeed imperative to avoid conveying contagions to the parts to be treated by any contact liable to result in recurrence of the disorders intended to be treated or development of other disorders by indirect effect. To this end, the protection end piece (33) advantageously has a height of between 10 and 20 millimeters.

Furthermore, to release the gas pressure due to ejection of the fluid, the wall of the protection end piece (33) is provided with one or several orifices. The orifices are preferably situated in the lower quarter of the length of the protection end piece (33), or at least in the last third of the length of the end piece (33). The number of the orifices is to be chosen such that the fluid rate at the level of the orifices is negligible in face of the ejection rate of the cold fluid.

Advantageously, the protection end piece (33) is transparent to facilitate its positioning around the area to be treated.

Furthermore, to preserve the shape of the jet at the outlet of the ejection nozzle (22), the protection end piece (33) is of truncated cone shape open towards the area to be treated.

In an advantageous configuration, the device (1) also comprises a membrane seal (34) which is attached to the free end of the protection end piece (33).

The membrane seal (34) is designed to limit the area to which the fluid is applied. To this end, the membrane seal (34) comprises an orifice (35) which, when the membrane seal (34) is attached to the end of the protection end piece (33), is arranged in the ejection axis of the fluid. For treatment of warts, the orifice (35) has a diameter of 5 to 10 millimeters and preferably on the order of 6 millimeters. For treatment of brown spots, it advantageously has a diameter of 10 to 20 millimeters and preferably on the order of 15 millimeters.

Advantageously, the membrane seal (34) is transparent to facilitate positioning of the orifice (35) facing the area to be treated.

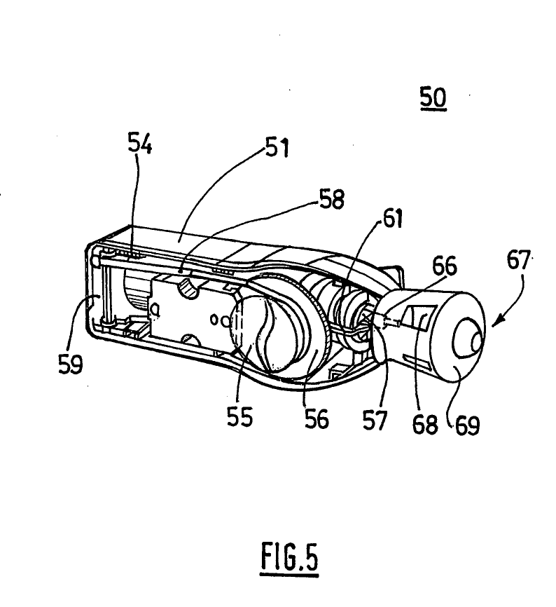

With reference to FIGS. 5 to 8, another fluid application device (50) is described.

The device (50) is formed of two half shells (51, 52) clipped together, with each of the half shells forming a side of the device (50).

In the example illustrated, the clip-fitting is performed by means of six tongues (53) distributed along the edge of the half shell (52), on the inside face, with these tongues (53) being designed to be received respectively in a recess (54) provided and located for this purpose on the inside face of the shell (51). The recesses (54) and the tongues (53) are configured to prohibit, or render very difficult, withdrawal of the tongues once the two half shells are clipped together.

A container (65) constituting the fluid reservoir is housed between these two half shells (51, 52).

The container (65) comprises an internal pocket and a crimped pump which, once pushed in, releases the gas (not illustrated). The chosen gas, in this case R152A, is injected into the pocket and between the walls of the pocket and the container to create, together with the air around the pocket, a pressure between the walls that is greater than the equilibrium pressure (or saturating vapor pressure) of the R152A in the pocket.

The ratio of these pressures is to be determined as a function of the ejection rate of the desired gas. Care is to be taken, however, to avoid the difference between the pressures being too great to prevent excessively rapid gas diffusion. Consequently and preferentially, provision is to be made for a volume of 2.5 g (corresponding to a pressure of between 6.2 bars and 7.6 bars at 20° C.) between the walls of the pocket and the container and of 9 g (corresponding to a pressure of between 8.0 and 9.5 bars at 20° C.) inside the pocket to allow dispensing 13 gas ejections and therefore 13 doses of treatment with a pressure within the pocket ranging from 7.6 bars for the first ejection to 6.4 bars for the 13^{th} ejection.

The container (65) is maintained between the half shells (51, 52), in a receiving envelope (60) provided for this purpose.

The envelope (60) is mounted pivoting on the edge of the bottom half-wall of the shell (52), around a transversal axis AA1.

The nozzle of the device (50) is comprised of a jet (66), the outlet orifice of which advantageously has a diameter of 0.20 millimeters

The dimensions and shape of the jet (66) are selected to allow control of the flow rate and direction of the gas. More specifically, the dimensions of the jet (66) are determined as a function of the gas used and its properties, in addition to the pressure maintained in the pocket of the container (65). The aim is to obtain gas ejection within a very short space of time, on the order of three seconds, with a level of cooling on the skin, at around −5°, such that a painless thermal shock is induced within a few seconds (on the order of five seconds).

The device (50) furthermore comprises, like the device previously described, a trans-parent protection end piece transparent the wall of which is provided with orifices for release of the gas pressure and the end of which is provided with a membrane seal (69).

Advantageously, these orifices (68) are located in the lower half of the end piece (67) (i.e., the half nearest to the skin when the end piece is positioned against the skin). The orifices (68) are sized and arranged to allow sufficient escape of gas to avoid creating whirlpools inside the end piece (67) that may deviate the trajectory of the jet.

Advantageously, the length of the protection end piece (67) is a function of the optimum distance between the outlet of the jet (66) and the skin, i.e., 33 millimeters: below this value, the speed of the fluid causes projections of fluid on to the walls of the protection end piece, subsequently resulting in a loss of fluid; above this value, evaporation is excessive.

FIG. 5 illustrates the device (50), the half shell (52) of which has been removed to show a part of the timer triggering system.

The timer triggering system comprises a rearming lever (55) which is interdependent of a wheel (56), known hereafter as the “cam wheel.” In the same manner as the cam wheel (24) of the example previously described, the purpose of the cam wheel (56) is to control release or discontinuation of release of the fluid. This control will be described below.

A spring (58), designed to supply the necessary energy to dispense a dose of fluid is attached, wound, by one of its ends to the cam wheel (56), with the other end being attached to the side (59) of the half shell (51) forming the bottom half-wall of the device (50). It is maintained between the rearming lever (55) and the cam wheel (56).

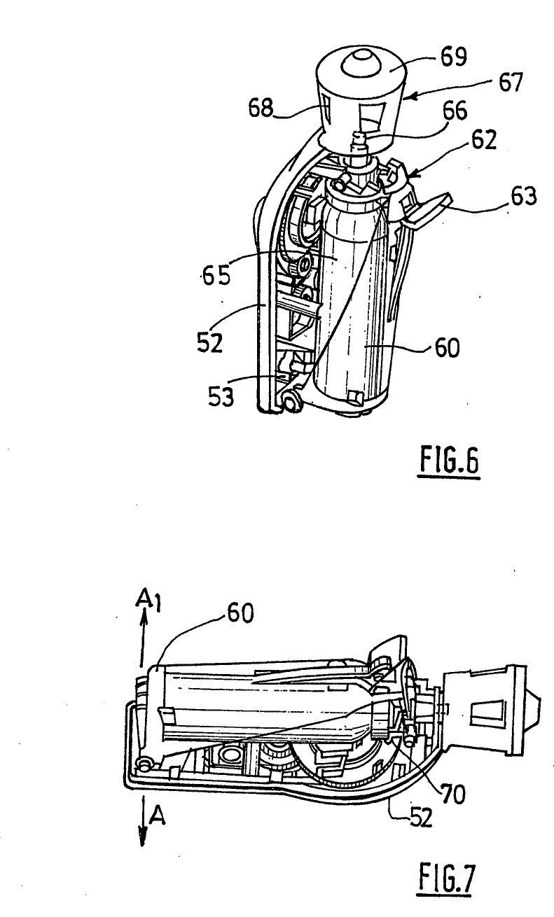

FIGS. 6 and 7 illustrate the device (50), the half shell (51) of which has been removed to show the means used to operate the cam wheel (56) and therefore initiate or halt release of the fluid.

The means include a triggering lever and a rocker lever (61).

The triggering lever includes the envelope (60), the pivoting movement of which is activated by a triggering button (63). The triggering lever will be subsequently numbered 60.

The rocking lever (61) is arranged to have an end (70) remaining in contact with the cam wheel (56). The latter therefore has a side on which the rearming lever (55) is mounted, with the other side being configured to receive the friction end (70) of the rocking lever (61).

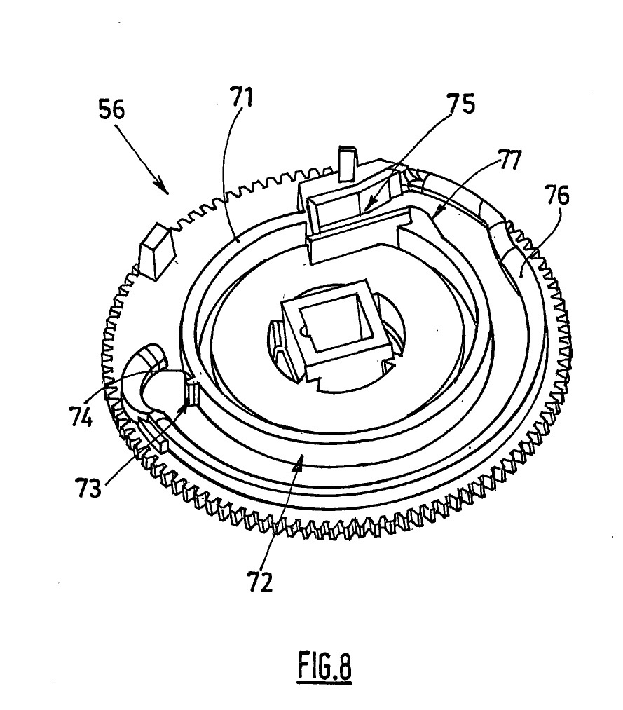

FIG. 8 illustrates a front view of the cam wheel (56) designed to receive the friction end (70) of the rocking lever (61). For this purpose, the cam wheel (56) comprises a guide rib (71) designed to guide the rocking lever (61) over its outside edge (72). The outside edge (72) of the guide rib (71) is provided with an extension (73) forming a locking lug for the rocking lever (61) during rearming of the lever (55). The rocking lever (61) is locked by the side (74) of the extension (73).

The cam wheel (56) also comprises a locking tab (75) designed to stop the movement of the rocking lever (61), the locking tab (75) being preceded by a boss (77). The movement exerted on the rocking lever (61) by the boss (77) results in discontinuation of dispensing of the fluid via the component forming a hook (63). Halting of the rocking lever (61) by the locking tab (75) results in turn in locking of the triggering lever (60).

Advantageously, the locking tab (75) is U-shaped.

According to a preferred construction, the cam wheel (56) comprises a second rib (76) allowing the rocking lever (61) to be maintained and guided between the two ribs (71, 76). The advantage of the second rib (76) lies in not requiring the spring effect necessary for a rocking lever (61) when the cam wheel (56) has only one rib (71).

The rocking lever (61) is rendered interdependent of the triggering lever (60) by means of a component forming a hook (62).

The timer associated with the cam wheel (56) comprises six components including a plate, an anchor, two clams and two pinions.

Furthermore, the rearming lever (55) and the triggering button (63) are arranged to extend outside the half shells (51, 52).

The fluid dispensing system operates as follows.

The rearming lever (55) is turned to prime the timer, which at the same time moves the cam wheel (56). The lever (55) is turned until the rocking lever (61) locks against the extension (73) forming the stop position locking tab.

At the same time, the spring (58), maintained between the rearming lever and the cam wheel, is set in motion by the movement of the cam wheel (56), coiling around itself.

Preferably, priming is performed by rotating the rearming lever by a half turn (55).

The fluid application device (50) is then ready for use for dispensing of a defined dose of fluid for a determined period of time.

The fluid dispensing operation is initiated by manually pressing the triggering button (63) towards the top of the device (50), in the direction of the nozzle. In its movement, the triggering button (63) drives the triggering lever formed by the envelope (60) in a pivoting movement in the direction of the shell (52). In its movement, the triggering lever (60) results in lowering of the component forming a hook (63), which lifts the rocking lever (61) to allow passage of the extension (72). Since the rocking lever (61) is no longer locked with the cam wheel (56), the latter is set in rotation under the action of the spring (58). The timer is subsequently triggered.

At the same time, the triggering lever (60), by pivoting, presses on the bottom of the cylinder, initiating opening travel of the pump crimped in the container (65), which releases the gas.

The gas is subsequently dispensed until the rocking lever (61) is brought into contact with the boss (77) provided on the cam wheel (56). The cam wheel (56) continues its rotational movement until the rocking lever (61) reaches the locking tab (75). The movement of the triggering lever (60) is subsequently locked.

To repeat dispensing of fluid, a timer repriming stage is to be repeated, with the arm of the rocking lever (61) moving from its stop position to its intermediate locking position under the action in the opposite direction of the traction exerted by the spring (58) and so forth.

The structures described above are examples. It is understood that those skilled in the art are capable of producing different structures without departing from the scope of the appended claims.

1-15. (canceled)

16. A device for application of a fluid to an area to be treated comprising:
a reservoir of fluid contained in an aerosol and maintained in a device in the form of a casing; and
a trigger that releases the fluid from the reservoir via an ejection nozzle and coupled to a timer system controlling duration of release of the fluid.

17. The device according to claim 16, wherein the timer system is mechanical comprising a gear system of cogwheels.

18. The device according to claim 17, wherein the timer system comprises a wheel controlling starting and stopping of the timer, with movement of the wheel being controlled by a rocking lever interdependent of the trigger.

19. The device according to claim 18, wherein the wheel comprises a substantially circular rib, the rib being provided on its outer edge with a tab allowing movement of the lever arm along an outer edge of the rib.

20. The device according to claim 18, wherein the wheel comprises a second rib radially locking the rocking lever, with the first and second ribs arranged to form a guide rail for the rocking lever.

21. The device according to claim 18, wherein the rocking lever is moved to an intermediate locking position by a rearming lever interdependent of the cam.

22. The device according to claim 21, wherein the rib comprises, on its outer edge, a substantially radial extension, the extension maintaining the rocking lever in a preliminary locking position.

23. The device according to claim 16, wherein the timer system comprises a gear system of cogwheels, the gear system comprising at least two wheels, with a first wheel controlling starting and stopping the timer and a second wheel controlling release or discontinuation of release of the fluid from the reservoir to the nozzle.

24. The device according to claim 23, wherein the first wheel is operated by the trigger with an arm forming a lever, the arm forming a lever being articulated to pass from a lowered position on the first wheel to a raised position and vice versa.

25. The device according to claim 24, wherein the timer system comprises first means for stopping operation provided with the arm forming a lever and acting on the first gear system.

26. The device according to claim 25, wherein the first means of stoppage comprises a lug arranged at an end portion of the arm, the lug configured to rest in a hole formed in the first wheel when the arm forming a lever is in a lowered position.

27. The device according to claim 23, wherein the time system further comprises second means of stoppage provided with a first wheel, the second means of stoppage assisting the first means of stoppage borne by the arm forming a lever.

28. The device according to claim 27, wherein the second means of stoppage includes a lug sized to contact the arm forming a lever when the arm is in a raised position.

29. The device according to claim 23, wherein the first wheel is driven by a traction spring surrounding a third wheel, the third wheel in contact with the second wheel such that, when the arm forming a lever is in a raised position, the first wheel is driven by traction exerted by the spring on the third wheel.

30. The device according to claim 23, wherein the second wheel controls release or discontinuation of release of the fluid by a release arm, with a free end of the arm having means capable of activating opening or closing the ejection nozzle.
